(19) United States
(12) Patent Application Publication
(10) Pub. No.: US 2004/0042844 A1
(43) Pub. Date: Mar. 4, 2004

(54) Binder with indexing extension

(76) Inventors: Michael C. Ettro, Maple Valley, WA (US); Michael Slattery, Yonkers, NY (US)

Correspondence Address: WINSTON & STRAWN, PATENT DEPARTMENT, 1400 L STREET, N.W., WASHINGTON, DC, 20005-3502, US

(21) Appl. No.: 10/233,611

(22) Filed: Sep. 4, 2002

(51) Int. Cl. B42F 13/00

(52) U.S. Cl. 402/73

(57) ABSTRACT

A ring binder for a filing system with a plurality of cover panels of a cover that are pivotally connected together for pivoting between open and closed cover positions. The cover defines an interior binder space between the cover panels in the closed cover position. A ring binding member is attached with the cover and includes rings that are openable and closeable for receiving and releasing pages and for binding and holding the pages inside the binder in the closed cover position. The binding member is preferably accessible in the open cover position. At least one of the cover panels comprises an indexing extension that extends beyond the cover panels that are disposed opposite thereto in the closed cover position by a distance sufficient for receiving and displaying indexing indicia visible from opposite sides of the first cover panel in the closed cover position and for viewing the indicia when the binder is disposed on a shelf substantially aligned with a plurality of other binders.

### FIELD OF THE INVENTION

The present invention relates to a binder for use in a filing system. More particularly, the invention relates to a ring binder configured to receive indexing indicia that is visible when the binder is among others on a shelf.

### BACKGROUND OF THE INVENTION

Filing systems, such as those commonly used in medical offices, include a plurality of folders with patient or other information. The folders have a tab that protrudes to receive a sticker that is part of an indexing system to help identify the folders, such as by the last name of the patient or by other criteria. Some of these folders include a flexible metal strip with two free ends to insert through holes in a stack of paper to hold the stack in the folder when the strip ends are bent against the stack.

Ring binders are known with a ring binding mechanism in which rings open and close to bind a stack of paper within a cover. These binders typically have sides of equal length. When placed among other binders on a shelf, they are usually stood on their lower edges and identified by indicia disposed directly on their spine.

A ring binder is needed that can be placed on a shelf in another position or used in conjunction with folders of a filing system and still be easily identified, such as part of an indexing system.

### SUMMARY OF THE INVENTION

The present invention relates to a ring binder for a filing system. A preferred embodiment of an inventive ring binder has a cover with a plurality of cover panels that are pivotally connected together for pivoting between open and closed cover positions. The cover and its panels define an interior binder space between the cover panels in the closed cover position.

A ring binding member is attached with the cover and has rings that are movable between an open binder position, configured for receiving and releasing pages, and a closed binder position, configured for binding and holding the pages inside the binder when the cover is closed. The ring binding member is preferably accessible in the open cover position.

A first cover panel includes an indexing extension that extends beyond the cover panels that are disposed opposite thereto in the closed cover position by a first distance sufficient for displaying indexing indicia thereon visible from opposite sides of the first cover panel in the closed cover position. This distance also allows the indicia to be viewed when the binder is disposed on a shelf substantially aligned with a plurality of other binders.

A second panel is disposed opposite the first panel in the closed position. Preferably, a spine is disposed between and pivotally connecting the first and second panels. The binding member can be attached to the spine or to other cover panels. Preferably, the binding member is disposed between and covered by the cover panels in the closed position. A second binding member is preferably attached to the cover and configured for attaching papers thereto.

The first cover panel preferably has a first main portion from which the indexing extension extends in a first direction. The first main portion overlaps another panel of the cover in the closed position. The indexing extension is preferably narrower than the first main portion in a second direction orthogonal to the first direction. The width of the indexing extension is preferably less than about 95% of the width of the first main portion along the second direction.

The indexing extension is also preferably at most about a quarter as long as the first main portion in the first direction. More preferably, the indexing extension about between 5% and 15% as long as the first main portion in the first direction. The binder has a binder length in a first direction, and the indexing extension preferably extends beyond the second cover in the first direction by at most about a fifth of the binder length. In the preferred embodiments, the indexing extension extends beyond all of the remaining cover panels in the closed cover position in the direction of the first distance.

One embodiment of the binder has a panel with a recessed edge in the first direction, preferably measured parallel to the spine and hinges. This recessed edge permits increased the size of and permits viewing of a larger area of the indexing extension, while permitting the cover panel with the recess to retain more material where it does not oppose the indexing extension in the closed cover position.

The present invention provides a visual file indexing system that can be employed with the convenience of ring binders.

### BRIEF DESCRIPTION OF THE DRAWINGS

FIG. 1 is a perspective view of a preferred embodiment of a ring binder constructed according to the present invention;

FIG. 2 is a front view thereof in an open cover position; and

FIG. 3 is a front view of another embodiment of the invention in an open cover position.

### DETAILED DESCRIPTION OF THE PREFERRED EMBODIMENTS

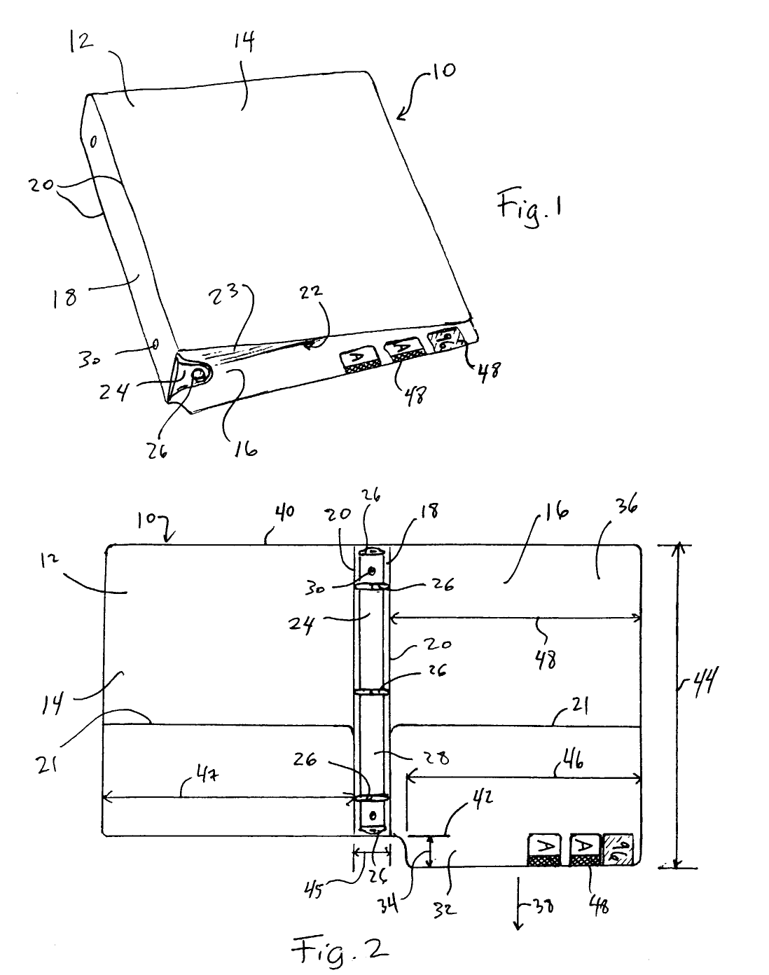

Referring to FIGS. 1 and 2, a preferred embodiment of a ring binder 10 has a cover 12. The cover 12 includes a plurality of cover panels, such as front panel 14, rear panel 16, and spine panel 18. Each other these panels 14, 16, 18 may include additional panels. In the preferred embodiments, front panel 14 is disposed opposite the back panel 18 in the closed cover position, with the spine panel 18 disposed between and pivotally connecting the front and back panels 14, 16.

The cover panels 14, 16, 18 are preferably pivotally connected together by a series of hinges 20 for pivoting between open and closed cover positions. The hinges 20 can comprise one or more score lines or weakened likes between the cover panels 14, 16, 18, as shown in FIGS. 1 and 2. In other embodiments, other types of hinges can be used, such as areas that are flexible continuations of the cover panels. The spine, for example, can include a continuously curving hinge area.

The cover panels 14, 16, 18 can be pivoted to a closed cover position, shown in FIG. 1, in which the cover panels 14, 16, 18 define and substantially enclose an interior binder space 22 between the cover panels 14, 16, 18 and within the cover 12. The panels 14, 16, 18 are also pivotable to an open position shown in FIG. 2, exposing the contents of the binder 10. The preferred panels have one or more pockets 21, preferably on the interior side thereof.

The spine 18 preferably has a lateral width that is substantially less than that of the front and back panels 14, 16. Preferably, the spine lateral width 45 is at most about 25% of the lateral widths 47, 48 of the front and back cover panels 14, 16, and more preferably at most about 20%. The spine lateral width is preferably at least about 10% and more preferably at least about 15% as wide as the front and back cover panels 14, 16.

A ring binding member or mechanism 24 is attached with the cover 12 to bind a stack of paper 23 within the interior space 22. The ring binding mechanism 24 includes rings 26 that can be opened and closed to receive and release or hold the stack or individual papers. The embodiment shown ins a three-ring binding mechanism with rings that toggle open and closed. Other embodiments have different ring configurations and numbers of rings. For instance, two or four or more rings may be used.

In the closed binder position, the ring binding mechanism 24 holds the stack in a position preferably within the cover 12, when it is closed. The ring binding 24 mechanism can have one or more controls, such as a button or lever 26, to facilitate opening sand closing. The ring binding mechanism 24 and any of its controls are preferably accessible to the user when the cover 12 is in the open position for inserting, removing, and viewing pages from the stack. Different opening and closing mechanisms may be employed for operating and controlling the position of the rings. The cover 12 and ring binding mechanism 24 are preferably configured to contain papers of standard sizes, such as letter size, legal size, or A3 or A4 size.

The ring binding mechanism 24 preferably has a base 28 that is fixed or otherwise attached to the cover 12. In the embodiment of FIGS. 1 and 2, the base 28 is attached by rivets 30, although other attachments as known in the art for ring binders can be employed. Also, base 24 is attached to and parallel to the spine panel 18 and its hinges 20, but may alternatively be attached to another of the cover panels 14, 16, 18 and in another orientation. One such position is attached to the front or back panel 14, 16 near and parallel to the spine 18. The preferred ring binding mechanism has a length extending along more than about 75% of the length in a parallel direction of the spine panel 18 or other panel to which it is attached or adjacent to the panel to which it is attached. The ring binding mechanism 24 is preferably disposed between and covered by the cover panels 14, 16, 18 in the closed cover position.

Back panel 16 of the cover 12 includes a main portion 36 and an indexing extension 32, such as an indexing tab, that extends therefrom in a first direction 38, preferably making the back panel 16 longitudinally the longest of the panels and the one that extends farthest in the first direction 38. The main portion 36 and indexing extension 32 preferably have a connection free from a hinge. Most preferably, there is no hinge between the main portion 36 and the indexing extension 32. The main portion 36 overlaps another cover panel, such as the front panel 14, in the closed cover position.

The indexing extension 32 extends beyond the front panel 14, which is disposed opposite to back panel 16 in the closed cover position, by a first distance 34. This first distance 34 is selected so that it is sufficient for receiving indexing indicia visible from opposite sides of the back panel 16 in the closed cover position. Preferably, the first distance 34 is also sufficient for viewing the indicia when the binder is disposed on a shelf substantially aligned with a plurality of other binders. In other embodiments, the indexing extension extends from other panels, such as the front panel or the spine, or from several of the panels. Preferably, when looking at the cover in the open position, the extension extends from the bottom right edge of the cove 12, or from the top left edge, if the cover 12 is viewed upside down, although other suitable arrangements can be used.

The indexing extension 32 preferably is at most about a quarter as long longitudinally as the main portion 36 in the first direction 34, more preferably at most about a fifth as long, still more preferably at most about 15% as long, still more preferably at most about 10% as long, and most preferably at most about 7% as long. The indexing extension is preferably at least about 3% as long as the main portion 36 in the first direction, and more preferably at least about 5% as long. The most preferred longitudinal length of the indexing extension is about between 0.5 inches and 1.5 inches.

These preferred longitudinal length ratios are also the preferred ratios of the longitudinal length of the indexing extension 32 to the total longitudinal length of the remainder of the cover 12, excluding the indexing extension 32, measured along the first direction 34 from edge 40 the panel that extends farthest from the extension 32 in a direction opposite from the first direction 34, to the base 42 of the indexing extension 32, where the extension protrudes from the opposing cover panel(s) 14 in the closed cover position.

The ratio of the longitudinal length of the indexing extension 32 to the longitudinal length 44 of the cover 12 taken as a whole, including the indexing extension 32, is preferably about 5% smaller than the ratios listed above comparing the preferred longitudinal lengths of the indexing extension 32 to the main portion 36. In one embodiment, the indexing extension 32 extends beyond the opposing front cover panel 14 in the first direction 34 by at most about a fifth of the binder length 44 in the closed cover position, which in the embodiment of FIGS. 1 and 2 is equal to the binder length in the open position. As the most preferred indexing extension 32 extends beyond all of the remaining cover panels 14, 16, 18 in the closed cover position in the first direction 38, the indexing extension can be seen from any side of the binder in the closed cover position.

Indexing extension 32 has a lateral width 46 in a lateral direction, which is oriented at an angle to the longitudinal direction 38, preferably about a right angle, and preferably which follows the side of the main portion 36 adjacent the indexing extension 32. The width 46 of the indexing extension can be the same as that of the main portion 36 of the back cover panel 16. Preferably, however, the indexing extension 36 has a lateral width 46 which is at most about 95% or the width 48 of the main portion 36 or entire back panel 16, more preferably at most about 90% and at least about 50% thereof.

Indexing indicia, such as indexing stickers 48, are shown disposed on the indexing extension 32. The stickers are preferably color or pattern coded and have letters or numbers to facilitate in their rapid identification when the binder is among others on a shelf. Preferably, the position of the indexing extension 32 with respect to the cover panels 14, 16, 18 and the sticker 48 position on the indexing extension 32 are selected for viewing when a plurality of similar binders are disposed next to each other on their spines 18 on a shelf. Thus, a shelf filing system is provided, which allows the use of ring binders.

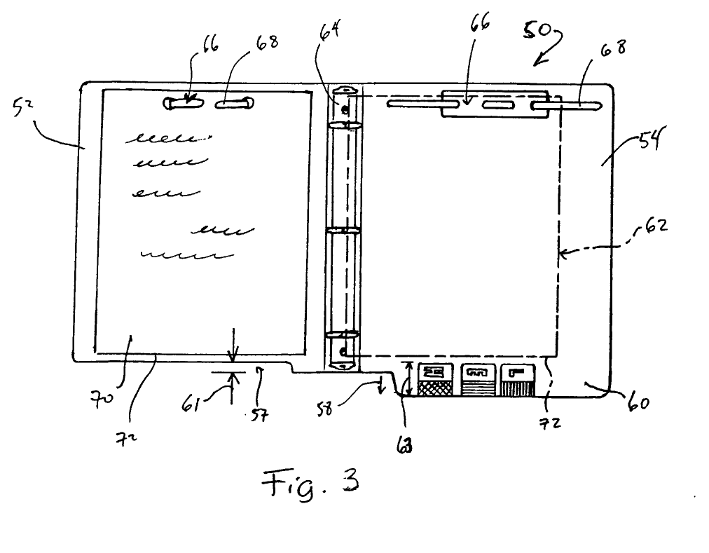

Referring to FIG. 3, another ring binder embodiment 50 has a front cover 52, which is disposed opposite the back panel 54 in the closed cover position. The front panel 52 defines a recessed edge 56 with a recess facing in the direction 58 in which indexing extension 60 extends. Thus, the remainder of the front panel 52 can be enlarged where it does not overlap the indexing extension 60 in the closed cover position.

The recess 57 preferably has a longitudinal depth 61 measured to the longitudinal edge 63 of the front or back panel 52, 54. The recess depth 61 is preferably at most about 75% and more preferably at most about 50% of the longitudinal length 63 of the indexing extension 60, measured from the overlapping position of the recess 57. The recessed edge 56 preferably extends longitudinally in the direction 58 sufficiently to cover the longitudinal edges 72 of any paper stacks bound to the binder 50.

Binder 50 has a stack of paper 62, shown in phantom lines attached to the closed ring-binding mechanism 64. Second and third binding mechanisms 66 of types known in the art, are attached to the cover, in this particular embodiment to the front and back covers 52, 54. The additional binding mechanisms 66 shown include a flexible metal band 68 that can be inserted in holes in stacks of paper, such as near the top edge thereof. The binding mechanism 66 on the front cover 52 is shown holding a paper stack 70.

While illustrative embodiments of the invention are disclosed herein, it will be appreciated that numerous modifications and other embodiments may be devised by those skilled in the art. For example, A transparent portion can be added to opaque opposing cover panels to overlap the indexing extension in the closed position but permit viewing of the indicia thereon. Additionally, other binder embodiments have different numbers and configurations of cover panel or sections. Therefore, it will be understood that the appended claims are intended to cover all such modifications and embodiments that come within the spirit and scope of the present invention.

What is claimed is:

1. A ring binder for a filing system, comprising:
a cover comprising at least first and second cover panels that are connected for pivoting between open and closed cover positions and defining an interior binder space in the closed cover position, the second cover panel blocking the view of a portion of the first cover panel in the closed cover position;
a ring binding member operatively associated with the cover and comprising rings that are movable between an open binder position configured for receiving and releasing pages and a closed binder position configured for binding and holding the pages inside the binder in the closed cover position, wherein the binding member is accessible in the open cover position;
wherein the first cover panel comprises an indexing extension that extends beyond the second cover panel by a first distance sufficient for displaying indexing indicia thereon visible from opposite sides of the first cover panel in the closed cover position and for viewing the indicia when the binder is disposed on a shelf substantially aligned with a plurality of other binders.

2. The binder of claim 1, wherein the second cover panel is disposed opposite from the first cover panel in the closed cover position

3. The binder of claim 2, wherein the cover comprises a spine disposed between and pivotally connecting the first and second panels.

4. The binder of claim 3, wherein the binding member is attached to the spine.

5. The binder of claim 4, wherein the first distance is substantially longitudinally aligned with the spine.

6. The binder of claim 1, wherein the first cover panel comprises a first main portion from which the indexing extension extends in a first direction, the first main portion overlapping another panel of the cover in the closed position, and the indexing extension being narrower than the first main portion in a second direction orthogonal to the first direction.

7. The binder of claim 6, wherein the indexing extension has a width along the second direction that is less than about 95% of the width of the first main portion along the second direction.

8. The binder of claim 1, wherein the first cover panel comprises a first main portion from which the indexing extension extends in a first direction, the indexing extension being at most about a quarter as long as the first main portion in the first direction.

9. The binder of claim 8, wherein the indexing extension about between 5% and 20% as long as the first main portion in the first direction.

10. The binder of claim 1, wherein:
the binder has a binder length in a first direction;
the second cover panel is disposed opposite from the first cover panel in the closed cover position; and
the indexing extension extends beyond the second cover in the first direction by at most about a fifth of the binder length.

11. The binder of claim 1, wherein the indexing extension extends beyond all of the remaining cover panels of the cover in the closed cover position in the direction of the first distance.

12. The binder of claim 1, wherein the binding member is disposed between and covered by the cover panels in the closed position.

13. A filing system, comprising:
the binder of claim 1; and
the indexing indicia.

14. The binder of claim 1, further comprising another binding member attached to the cover and configured for attaching papers thereto.

15. The binder of claim 1, wherein the second panel is disposed opposite the first panel in the closed position, wherein the second panel is pivotally associated with the first panel by at least one hinge, the second panel defining a recessed edge that is recessed in the direction of the first distance.

16. A ring binder for a filing system, comprising:
a cover comprising a spine and at least front and back cover panels that are connected to the spine for pivoting between open and closed cover positions and defining an interior binder space therebetween in the closed cover position;
a ring binding member attached to the cover and comprising rings that are movable between an open binder position configured for receiving and releasing pages and a closed binder position configured for binding and holding the pages inside the binder in the closed cover position, wherein the binding member is accessible in the open cover position;
wherein one of the cover panels comprises an indexing extension that extends beyond the other cover panel(s) by a first distance sufficient for displaying indexing indicia thereon visible from opposite sides of said one cover panel in the closed cover position and for viewing the indicia when the binder is disposed on a shelf substantially aligned with a plurality of other binders.

17. The ring binder of claim 16, wherein the back cover panel comprises the indexing extension and is longer than the other cover panels.

18. The ring binder of claim 16, wherein the indexing extension is configured and dimensioned such that the indexing indicia thereon is visible from opposite sides of said one cover panel in the closed cover position and for viewing the indicia when the binder is disposed on the spine panel on a shelf substantially aligned with a plurality of other binders disposed on their spines.
